(19) United States
(12) Patent Application Publication
(10) Pub. No.: US 2020/0380828 A1
(43) Pub. Date: Dec. 3, 2020

(54) SYSTEM AND METHOD FOR A SELF BIASING BET

(71) Applicants: Oren Zbeda, Bnei-Brak (IL); Riki Rebecca Zur Tobul, Surfside, FL (US)

(72) Inventors: Oren Zbeda, Bnei-Brak (IL); Riki Rebecca Zur Tobul, Surfside, FL (US)

(21) Appl. No.: 16/425,986

(22) Filed: May 30, 2019

(51) Int. Cl. G07F 17/32

(52) U.S. Cl. CPC G07F 17/3262; G07F 17/323; G07F 17/3211; G07F 17/3288

(57) ABSTRACT

A game of conditional probabilities may include a set of rules and/or outcomes that previous to the start of the game are characterized by a first set of un-conditional probabilities. Optionally once the game begins, the actions of the players may condition the probabilities and/or change the probabilities of various outcomes. For example, players may bet on what will be the least bet upon of a set of choices. The act of betting changes the probability of any given choice being the least chosen. Optionally the game may be used for demonstrating statistics and/or for gambling. In some embodiments, a payout schedule is designed to always benefit a house handling the game. Alternatively or additionally, a payout schedule is designed to never lose for the house. Alternatively or additionally, a payout schedule is designed to be statistically advantageous for the house.

### FIELD AND BACKGROUND OF THE INVENTION

The present invention, in some embodiments thereof, relates to a system and method for self-biased betting and, more particularly, but not exclusively, to a game for gambling and/or teaching probability.

U.S. Pat. No. 8,275,695 appears to disclose, “Methods and systems for engaging in enhanced parimutuel wagering and gaming. In one embodiment, different types of bets can be offered and processed in the same betting pool on an underlying event, such as a horse or dog race, a sporting event or a lottery, and the premiums and payouts of these different types of bets can be determined in the same betting pool, by configuring an equivalent combination of fundamental bets for each type of bet, and performing a demand-based valuation of each of the fundamental bets in the equivalent combination. In another embodiment, bettors can place bets in the betting pool with limit odds on the selected outcome of the underlying event. The bets with limit odds are not filled in whole or in part, unless the final odds on the selected outcome of the underlying event are equal to or greater than the limit odds.”

U.S. Pat. No. 8,758,111 appears to disclose, “a parlay style wager. Such a wager may include a parlay of a comparison game. Such a wager may include a parlay of a comparison game that is based on multi game games.”

U.S. Pat. No. 8,758,109 appears to disclose, “method or apparatus that allow a user to choose a source of random numbers or other information that may be used as the basis for a game. Other examples of methods, apparatus, games, embodiments, and so on are described.”

Additional background art includes U.S. Pat. Nos. 9,697,695, 7,344,440, 7,140,964, 7,387,571, 5,984,779, 7,344,440 and 10,217,327.

### SUMMARY OF THE INVENTION

According to an aspect of some embodiments of the invention, there is provided a method of playing a game including: suppling a set of rules wherein prior to playing a probability of outcomes is governed by an unconditioned probability; placing bets on the outcomes; changing the probability of the outcomes as a result of the placing the bets.

According to some embodiments of the invention, a bettor places a bet on an outcome decreases a chance of a chosen outcome winning.

According to some embodiments of the invention, the outcomes include what will be a least bet upon outcome.

According to some embodiments of the invention, the method further includes: publicizing rules of the game and the unconditioned probability of the outcomes.

According to an aspect of some embodiments of the invention, there is provided a method of playing a game including: displaying a set of choices to a plurality of bettors; collecting bets from the plurality of bettors, each bet on a respective choice of the choices; determining a least chosen of the choices; and paying a payout to those bets who chose the least chosen of the choices.

According to some embodiments of the invention, there are n choices and the payout is n times an amount bet.

According to some embodiments of the invention, the method further includes sending over a network to a remote bettor of the plurality of bettors the set of choices and wherein the displaying to the remote bettor is on a network computing device.

According to some embodiments of the invention, the method further includes: transmitting a bet by the remote bettor to a game server using the network computing device over the network.

According to some embodiments of the invention, the displaying includes displaying a set of images to the plurality of bettors.

According to some embodiments of the invention, the method further includes: displaying interim results to the plurality of bettors and collecting further bets after displaying the interim results.

According to some embodiments of the invention, the interim results include an interim least chosen choice.

According to some embodiments of the invention, the paying is based on a final least chosen choice after the further bets.

According to some embodiments of the invention, the method further includes displaying a result of the determining.

According to some embodiments of the invention, the displaying is configured to hide a statistical distribution of the result.

According to some embodiments of the invention, the displaying is limited to the bettors who actually bet.

According to some embodiments of the invention, there are n choices and the payout is greater than n times an amount bet but small enough that a house always wins.

According to some embodiments of the invention, there are n choices and the payout is greater than n times an amount bet but small enough that a house never loses.

According to some embodiments of the invention, the method further includes inhibiting communication among the plurality of bettors during the game.

According to some embodiments of the invention, the method further includes presenting motivational material to the plurality of bettors during the game.

According to an aspect of some embodiments of the invention, there is provided a method playing a game including: presenting a set of choices to a plurality of players; each player selecting at least one choice; deciding a winner who chooses a least chosen choice.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer, and may not be feasible or practical for performing purely manually, by a human expert. A human expert who wanted to manually perform similar tasks might be expected to use completely different methods, e.g., making use of expert knowledge and/or the pattern recognition capabilities of the human brain, which would be vastly more efficient than manually going through the steps of the methods described herein.

Data and/or program code may be accessed and/or shared over a network, for example the Internet. For example, data may be shared and/or accessed using a social network. A processor may include remote processing capabilities for example available over a network (e.g. the Internet). For example, resources may be accessed via cloud computing. The term “cloud computing” refers to the use of computational resources that are available remotely over a public network, such as the internet, and that may be provided for example at a low cost and/or on an hourly basis. Any virtual or physical computer that is in electronic communication with such a public network could potentially be available as a computational resource. To provide computational resources via the cloud network on a secure basis, computers that access the cloud network may employ standard security encryption protocols such as SSL and PGP, which are well known in the industry.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a game applying conditional probabilities in accordance with an embodiment of the present invention;

FIG. 2 is a flow chart illustration of applying conditional probabilities to a game in accordance with an embodiment of the current invention;

FIGS. 3-5 are schematic illustrations of outcomes of a game of conditional probabilities in accordance with an embodiment of the current invention;

FIG. 6 is a schematic illustration of a system for remote play of a game of conditional probabilities in accordance with an embodiment of the current invention;

FIG. 7 is a flow chart illustration of a round of a game in accordance with an embodiment of the current invention;

FIG. 8 is a flow chart illustration of a two-round game in accordance with an embodiment of the current invention;

FIG. 9 is a schematic illustration of game in accordance with an embodiment of the current invention; and

FIG. 10 is a schematic illustration of a game applying conditional probabilities in accordance with an embodiment of the present invention.

### DESCRIPTION OF SPECIFIC EMBODIMENTS OF THE INVENTION

The present invention, in some embodiments thereof, relates to a system and method for self-biased betting and, more particularly, but not exclusively, to a game for gambling and/or teaching probability.

### Overview

An aspect of some embodiments of the current invention relates to a game where unconditional probabilities are conditioned by choice of bettors. In some embodiments, a payoff that appears fair based on unconditioned statistics favors a particular party according to conditional statistics. For example, a game may pay off a bettor who chooses a least bet upon outcome. The act of betting biases the event away from the outcome chosen by the bettor. In some embodiments, the game may be used as a demonstration to help teach the principles of conditional statistics. Alternatively or additionally, the game may be used as a casino game and/or in on-line gambling.

### Exemplary Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

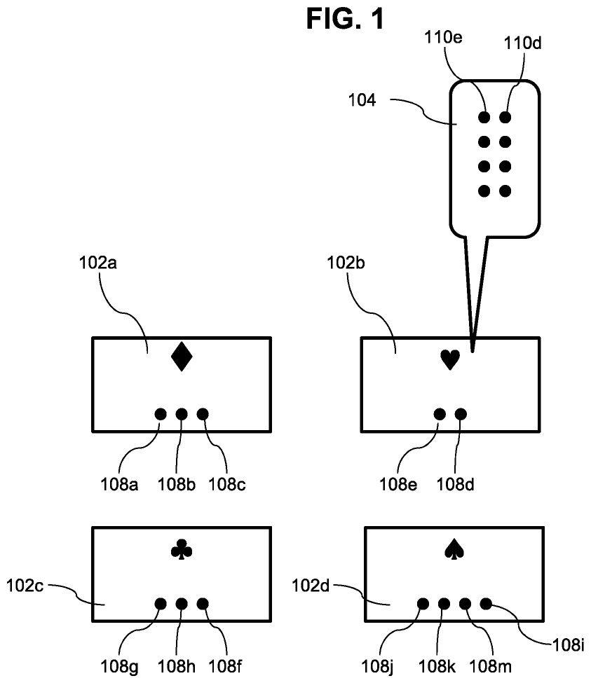

Referring now to the drawings, FIG. 1 is a schematic illustration of a game applying conditional probabilities in accordance with an embodiment of the present invention. For example, bettors are asked to bet what will be the least bet upon of a number of choices. Each winning bet will receive a reward. Before betting begins, the various outcome (e.g. the probability that each choice with be the least chosen) appear to have non-conditioned probabilities (for example substantially equal probabilities). Optionally, once a bet is placed, the act of places the bet tilts the odds of the chosen outcome.

In an exemplary embodiment, bettors place bets 108a-108i on which will be the least bet upon n=4 choices (e.g. diamonds 102a, hearts 102b, clubs 102c and spades 102d). The unconditional probability of each choice being the least chosen appears to be about even for example a probability of 1/n=¼ that each choice will be the least chosen. Optionally, in the case of a tie, a single winning bet of the tied choices will be selected at random.

In the exemplary embodiment, the distribution of betting is illustrated by 12 bets 108a-108i. For example, three bets 108a, 108b and 108c are placed on the choice 102a “diamonds”. For example, two bets 108d and 108e are placed on the choice 102b “hearts”. For example, three bets 108f, 108g and 108h are placed on the choice 102c “clubs”. For example, four bets 108i, 108j, 109k and 108m are placed on the choice 102d “spades”.

In the exemplary embodiment, the least chosen item is 102b “hearts”. In accordance to the exemplary rule stated above bets 108e and 108d win. Further based on the exemplary rule stated above, winning bets 108d and 108e which chose the least chosen choice “hearts 102b are rewarded with a pay out 104 based on the unconditioned probabilities 1/n, e.g. each bet 108d and 108e of one token receives a prize 110d and 110e respectively of n=4 tokens. In the exemplary outcome, of the 12 tokens that were bet 108a-108m only 8 tokens were paid out 104 and four tokens are kept by the “house”.

Looking at the exemplary results, it is apparent that the superficially fair pay out 104 (e.g. 1/n) based on the unconditional probabilities leads, in fact, to a win for the “house”. In fact, a careful accounting shows that, in the exemplary case, the “house” can never lose. In fact, according to the exemplary rules, if the number of bets is not divisible by four, the house will always win and even if the number of bets is divisible by four the house can be expected to usually win and may lose or come out even only in the case that the bets are divided perfectly evenly between all of the choices and depending on how the rules treat the case of a tie.

In some embodiments, a game of “guess the least popular choice” may be played with a conventional payout scheme. For example, the game total betting may be divided between the winners. For example, in the case of the example of FIG. 1, the total number of betted tokens (12 tokens of bets 108a-108i) may be divided between the two winning bets (e.g. 108e and 108d and thus, the winnings of each one (110e and 110d) would be 12/2=6 chips). Optionally, the total game betting will be divided between the house and the winners. For example the house may take a fixed portion of the betting and/or the rest may be divided among the winners. For example, the house may take one sixth of the total betting and divide the rest between the winners. For example, in the case of the exemplary embodiment of FIG. 1, the house would take 12/6=2 tokens and divide the rest of the tokens between the winners, for example evenly. For example, winnings 110d and 110e would each receive 5 tokens.

In some embodiments, a game of “guess the least popular choice” may be played without gambling. For example, the game may be played as a social game. For example, the idea may be to reveal who is most individualistic and/or which couples are the most similar.

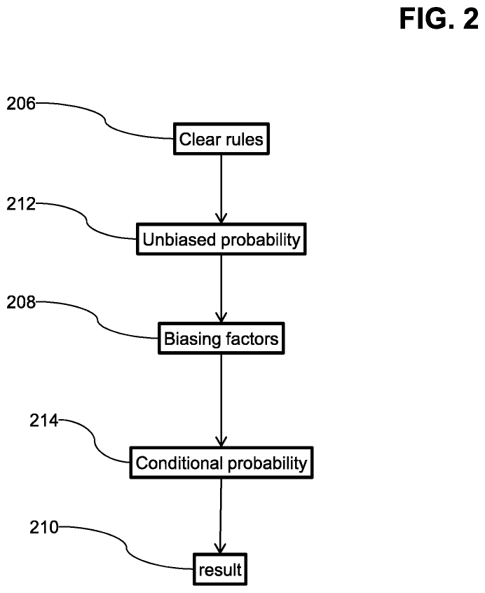

FIG. 2 is a flow chart illustration of applying conditional probabilities to a game in accordance with an embodiment of the current invention. In some embodiments, the game will have clear undisputable rules 206. Optionally, prior to the game the probabilities of an outcome may be described by unconditional probabilities 212. Biasing factors 208 (for example player actions in the game) optionally change the outcome probabilities to a set of conditional probabilities 214. The results 210 of the final outcome may influence a distribution of winnings.

In some embodiments, the rules 206 of a game may emphasize the unconditional probabilities. For example, a set of winnings may be defined and/or compared to the unconditioned probabilities 212. The unconditional probabilities may also be publicized (for example through advertisements and/or signs and/or an explanation of the game and/or in an illustration of the game etc.). The distribution of the outcomes may be presented in a way that obscures the effect of conditioning (for example, the unconditional statistics may be used to show that (at least prior to betting) individual outcomes each have a random chance (e.g. 1/n) of occurring). For example, probabilities that show the effect of conditioning (e.g. the probability of a person winning and/or of the “house” winning and/or conditioned statistics of winnings) may not be publicized prior to the game and/or may be publicized in a limited way and/or to a limited audience. Optionally, results 210 of the game may be used to illustrate conditional probabilities. Alternatively or additionally, the game may be played in a gambling setting and/or the results may be presenting in a way in which it is not obvious what were the conditional probabilities of various outcomes.

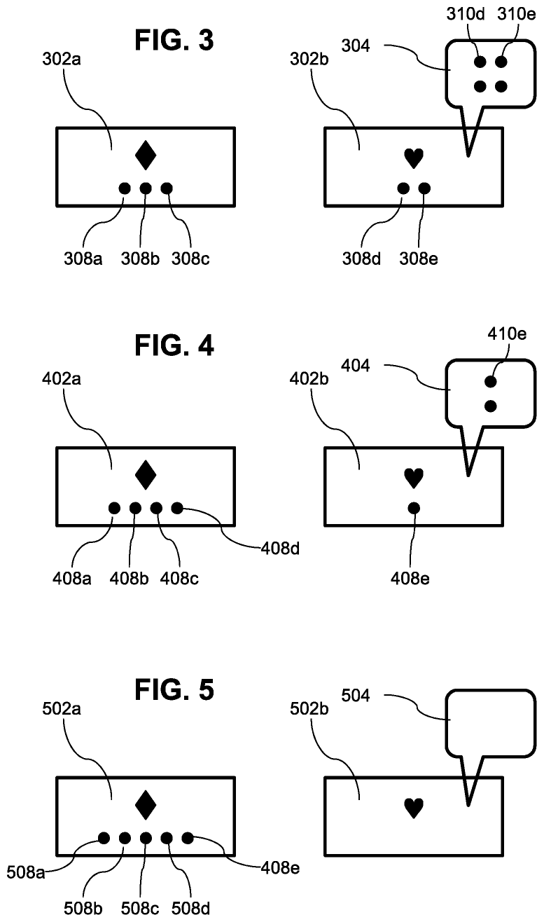

FIGS. 3-5 are schematic illustrations of outcomes of game of conditional probabilities in accordance with an embodiment of the current invention. In the exemplary game of FIGS. 3-5, five bets are placed on two choices n=2 (“diamonds” and “hearts” respectively). Optionally, in the game, a payout of two chips (n) is given for to each bet on the least chosen choice.

In the exemplary case the outcomes can be broken into three general categories: 1) Three players choose one choice and two players choose the second choice (e.g. in FIG. 3, three players bet 308a-308c “diamonds” 302a and two bet 308d and 308e “hearts” 302b). In such an exemplary case, the house collects five tokens (e.g. one token each from bets 308a-308e) and pays out 304 four tokens (e.g. tokens 310d and 310e covering bets 308d and 308e respectively) the house wins one token. 1) Four players choose one choice and one player chooses the second choice (e.g. in FIG. 4, four players bet 408a-408d “diamonds” 402a and one bets 308e “hearts” 402b). In such an exemplary case, the house collects five tokens (e.g. one token each from bets 408a-408e) and pays out 404 two tokens (e.g. token 310e covering bet 408e) the house wins three tokens. 3) All five players choose one choice and no player chooses the second choice (e.g. in FIG. 5, five players bet 508a-508e bet “diamonds” 502a and no one bets “hearts” 502b). In such an exemplary case, the house collects five tokens (e.g. one token each from bets 508a-508e) and pays out 504 no tokens, the house wins five tokens. Thus, in the illustrative case while according to the unconditional statistics, the house appears to be paying fairly, the house nevertheless always wins.

TABLE 1
results for five players, n = 2 choices with payout n = 2

| Hearts | Diamond | N ways | Pay | earn |
|---|---|---|---|---|
| 0 | 5 | 1 | 0 | 5 |
| 1 | 4 | 5 | 2 | 3 |
| 2 | 3 | 10 | 4 | 1 |
| 3 | 2 | 10 | 4 | 1 |
| 4 | 1 | 5 | 2 | 3 |
| 5 | 0 | 1 | 0 | 5 |

The potential results of conditional probabilities of the exemplary game with a payout of 1/n are illustrated in table 1. For example, Table 1, illustrates six possible combinations of 5 bets placed on two possible choices (e.g. diamonds or hearts). For example, looking at the first line of Table 1, there is N=5!/(5!0!)=1 way that all five of the contestants choose diamonds and none hearts. In that case the least chosen choice is hearts and no-one chose hearts so that the house Pays 0 tokens and the house Earns 5 tokens, all of the bettings.

For example, looking at the second line of Table 1, there are N=5!/(4!1!)=5 possible ways that one constant chooses hearts and four choose diamonds (e.g. contestant 1 chooses hearts and contestants 2, 3, 4 and 5 choose diamonds, contestant 2 chooses hearts and contestants 1, 3, 4 and 5 choose diamonds, contestant 3 chooses hearts and contestants 2, 1, 4 and 5 choose diamonds, contestant 4 chooses hearts and contestants 2, 3, 1 and 5 choose diamonds, contestant 5 chooses hearts and contestants 2, 3, 4 and 1 choose diamonds). In that case the least chosen choice is hearts and one bettor chose hearts so that the house Pays the winner n=2 and earns 3 tokens.

For example, looking at the third line of Table 1, there are N=5!/(3!2!)=10 possible ways that two constants choose hearts and three choose diamonds. In that case the least chosen choice is hearts and two bettors chose hearts so that the house Pays 4 tokens (e.g. n=2 tokens to each of the two winners) and earns 1 token.

For example, looking at the fourth line of Table 1, there are N=10 possible ways that three constants choose hearts and two choose diamonds. In that case the least chosen choice is diamonds and two bettors chose diamonds so that the house Pays 4 tokens (e.g. n=2 tokens to each of the two winners) and earns 1 token.

For example, looking at the fifth line of Table 1, there are N=5 possible ways that one constant chooses diamonds and four choose hearts. In that case the least chosen choice is diamonds and one bettor chose diamonds so that the house Pays the winner n=2 and earns 3 tokens.

For example, looking at the last line of Table 1, there is N=1 way that all five of the contestants may choose hearts and none diamonds. In that case the least chosen choice is diamonds and no-one chose diamonds so that the house Pays 0 tokens and the house Earns 5 all of the bettings.

Tallying up the outcomes we see that for a case with unbiased betting after a large number of rounds, for every ΣN=32 rounds the house wins 2(5×1+3×5+1×10)=60 tokens and the bettors bet 32×5=160 tokens and receive back 2(0×1+2×5+4×10)=100 tokens.

From the perspective of a player entering the game it appears that he is playing a fair game (his choice has a 1/n chance in the unconditioned probability before betting and if he wins, he will get n chips). In fact, the bettors always lose and over the average for every token bet receive only ⅝ of a token of winnings.

TABLE 2
results for five players, n = 2 choices
with payout of 2.5 for each winning bet

| Hearts | Diamond | N ways | Pay | earn |
|---|---|---|---|---|
| 0 | 5 | 1 | 0 | 5 |
| 1 | 4 | 5 | 2.5 | 2.5 |
| 2 | 3 | 10 | 5 | 0 |
| 3 | 2 | 10 | 5 | 0 |
| 4 | 1 | 5 | 2.5 | 2.5 |
| 5 | 0 | 1 | 0 | 5 |

Table 2 illustrates the results of a game where the house pays 2.5 chips to each winning bet. From the unconditioned view, this seems like a great game. The house is paying more than the inverse unconditional winning chances 1/n⁻¹=2. Nevertheless, also in this case the house never loses. In the worst cases where the bets are split as evenly as possible 2:3 the house comes out even. Optionally, the house may rig the game to always win for example by specifying a payout of less than 2.5. Optionally, the house may rig the game to always come out at least even for example by specifying a payout of 2.5.

TABLE 3
results for five players, n = 2 choices
with payout of 3.2 for each winning bet

| Hearts | Diamond | N ways | Pay | earn |
|---|---|---|---|---|
| 0 | 5 | 1 | 0 | 5 |
| 1 | 4 | 5 | 3.2 | 1.8 |
| 2 | 3 | 10 | 6.4 | −1.4 |
| 3 | 2 | 10 | 6.4 | −1.4 |
| 4 | 1 | 5 | 3.2 | 1.8 |
| 5 | 0 | 1 | 0 | 5 |

Table 3 illustrates the results of a game where the house pays 3.2 chips to each winning bet. From the unconditioned view, this seems like a great game. The house is paying more than the unconditional winning chances 1/n⁻¹=2. Nevertheless, in this case the house on the average comes out even e.g. after a large number of games for every 32 games the house earns on the average 2(5×1+1.8×5−1.4×10)=0. Optionally, the house may rig the game to win on the average for example by specifying a payout of less than 3.2.

In the case where the house may lose, the house may take precautions to prevent collusion between the players (a group of players in collusion may bias the bets towards an even split eventually causing the house to lose).

In some cases of betting on the least chosen choice, there may be a tie between two choices. Optionally in such a case the house may randomly choose a winning choice from the tied least chosen cases. Alternatively or additionally, the house may pay to all of the tied winners (this may stack the game against the house). Alternatively or additionally, the house may pay to all of the tied winners with a maximum total payment cap (for example payment may be capped at the total of all bets). Alternatively or additionally, the house may pay no-one in a tie (there is no single least chosen choice) (this may be to the advantage of the house and/or further stack the game against the players). Alternatively or additionally, in the case of a tie, the house may take the entire sum of bets and divide it among all the winners. Alternatively or additionally, in the case of a tie, the house may take divide the winning of one of the tied choices amongst the tied bettors (e.g. if the payout for a winning bet were four tokens and there were two tied winning choices, the players of each winning choice would get 4/2=2 tokens). In some embodiments, a game select the least chosen choice may be combined with a game of chance and/or include a random element.

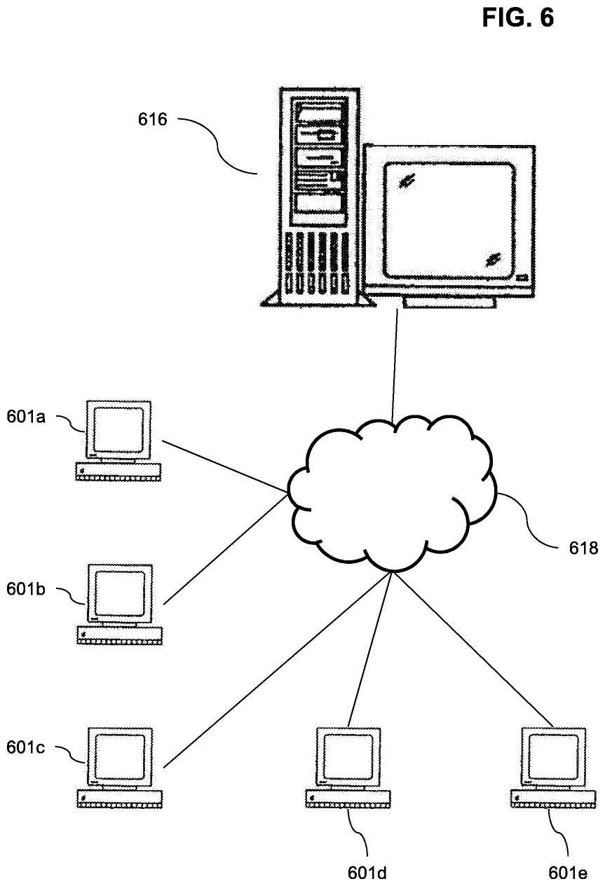

FIG. 6 is a schematic illustration of a system for remote play of a game of conditional probabilities in accordance with an embodiment of the current invention. In some embodiments, a server 616 may direct a remote game of chance in accordance with embodiments of the current invention. For example, the server 616 may send choices and/or information about a game over a network 618 to remote bettor devices 601a-601e. Optionally, the server 616 also receives bets from remote devices 601a-601e.

In some embodiments, server 616 may include one or more local and/or remote computing devices and/or memories and/or user interfaces. Optionally, server 616 is in communication with a financial server (for example a credit network and/or a bank) to arrange payment of bets and/or payouts.

In some embodiments, player devices 601a-601e may include various networked devices such as cell phones, personal computers, audio telephones, and/or casino-based terminals. For example, a casino-based terminal may include a money counting device e.g. to receive payment in the form of credit cards, coins, bills and/or chips. For example, a casino-based terminal may include a money distributing device e.g. to distribute payouts in the form of coins, bill and/or chips. Optionally a casino-based terminal may be placed in areas that are not strictly casinos, for example in game arcades, malls and/or stores etc.

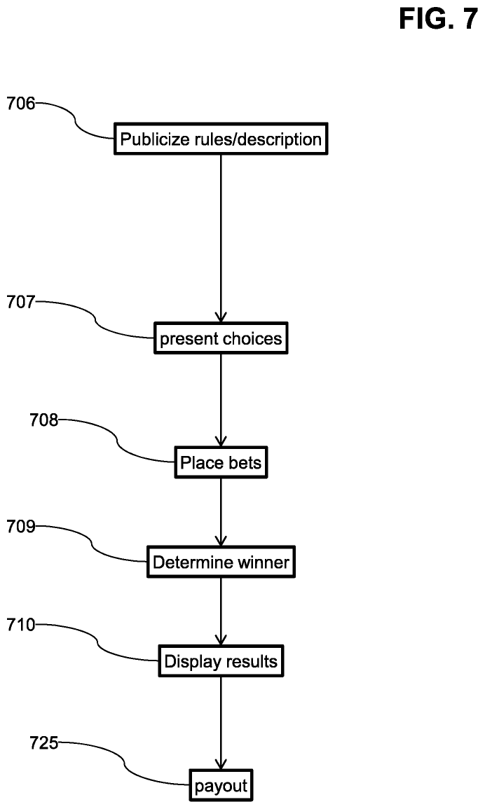

FIG. 7 is a flow chart illustration of a round of a game in accordance with an embodiment of the current invention. Optionally prior to the game, the game may be advertised and/or its rules publicized 706. In some embodiments, bettors will be presented 707 a set of choices. Optionally, the choices may be presented 707 visually and/or orally (for example over a display of a networked computing device and/or over a speaker of the device). For example, a certain number of different images may be displayed and each player may be allowed to bet 708 one or more times on one or more choices (for example bets may be placed by touching an image on a touch screen and/or using a keyboard and/or a pointing device and/or by speaking into a microphone). There is optionally a time limit after which betting closes. Optionally, after the close of betting, the system may determine 709 a winning bet, for example the choice that was least bet upon. The system may optionally display 710 selected results (for example which image was least chosen, how many people won and/or who won (e.g. real names and/or alias names), and/or the total payout). Optionally, enough data may be given out for players to understand the statistical outcome of the game. Optionally, results and/or a part thereof are sent to the public and/or just to bettors and/or are displayed locally (for example in a casino). Alternatively or additionally, enough data may be kept back such that the players and/or the public cannot determine the statistical outcome of the game (e.g. the number of winners may be given out but not the total number of players etc.). In some embodiments, further data may be made available at a later date and/or to a select group of people and/or to people who make a special request. Optionally, at the end of a round winnings will be paid 725 to winners. For example, winners may be given chips immediately (e.g. by a person running a game in a casino and/or by an outlet of a gambling machine). Alternatively or additionally, winnings may be credited to an account (e.g. a credit card and/or a bank account). Alternatively or additionally, winnings may be accumulated in a local currency (e.g. chips) and/or a local account (e.g. a casino account) that is paid to a player on demand and/or at the end of a session.

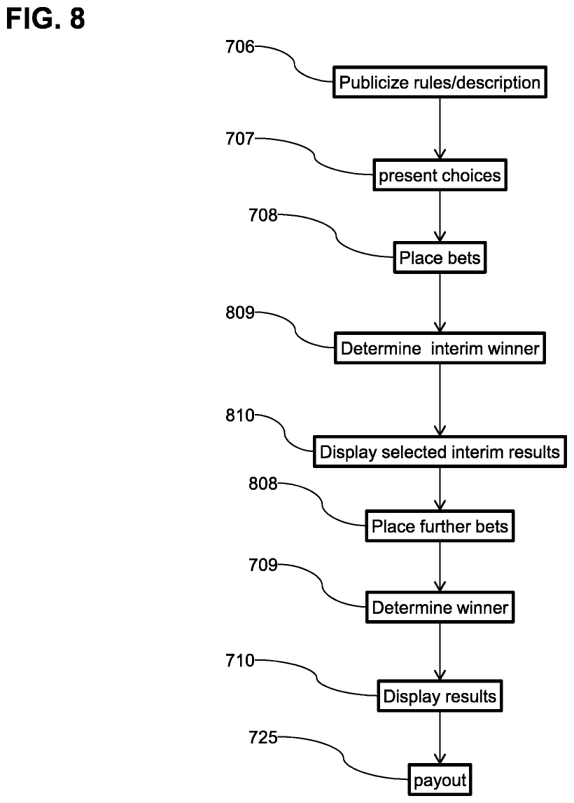

FIG. 8 is a flow chart illustration of a two-round game in accordance with an embodiment of the current invention. In some embodiments, selected information may be made available to players during the game. For example, at a game may be broken into two rounds. At the end of the first round an interim winner may be determined 809 and/or selected interim results may be displayed 810. For example, an interim least bet upon choice may be displayed to bettors who participated in the first round. Optionally these bettors may be allowed to place further bets 808 (e.g. either on the interim winner and/or on other choices). Optionally, after the second round of further betting 808 a final winner is determined 709 and/or payout 750 made. For example, payout 725 for all bets (first round bets 708 and final round bets 808) are made based on the final results 710.

In some embodiments, an element of skill will be included in the game. For example, displaying 810 selected interim results adds an element of skill into the game. For example, after seeing the interim results a player may use psychological reasoning to figure whether the interim winner will also be the final winner or maybe a lot of people will add bets to the interim winner and the final winner will be another choice. Other elements of skill may be involved in the game. For example, a user may use reasoning to figure choice will be most popular or least popular. Optionally, the system may give out selected information that may help add skill to the game. For example, bettors may be given information about the betting population (e.g. average age, location etc.), from the information, users may try to assess likely choices

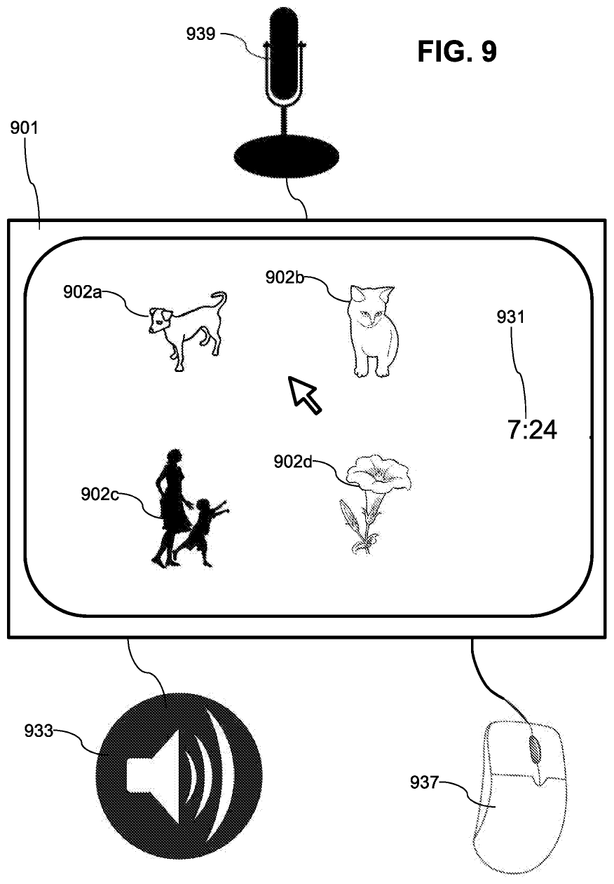

FIG. 9 is a schematic illustration of game in accordance with an embodiment of the current invention. In some embodiments, choices may be symbolized by images 902a-902d displayed on a viewer device (for example a computer monitor 901 and/or a touch screen). Optionally, images may include pictures of animals (e.g. 902a and 902b) and/or people (e.g. 902c) and/or other objects (for example flowers e.g. 902d). Alternatively or additionally, choices may be presented using a sound (for example over a loudspeaker 933). Optionally a user will use a pointing device 937 to choose an image and bet. For example, a user may touch the image on a touch screen and/or click the image using a pointer. Alternatively or additionally, the bettor may place a bet orally using a microphone 939. Optionally, the images may be customized according to the bettor and/or the same images may be shown to all bettors. Optionally a bettor may choice an image based on a strategy. In some embodiments, further information 931 may be displayed and/or announced to a bettor. For example, time left in a round may be displayed on a screen 901 and/or announced over a loudspeaker 933. Optionally promotional and/or motivational content is displayed and/or announced over the screen 901 and/or loudspeaker 933.

In some embodiments, various information will be displayed to players. For example, players may be given information as to who won or how many people won. For example, players may be given information as to how betting has proceeded. For example, players may be given information how much time there is left to bet before a round ends.

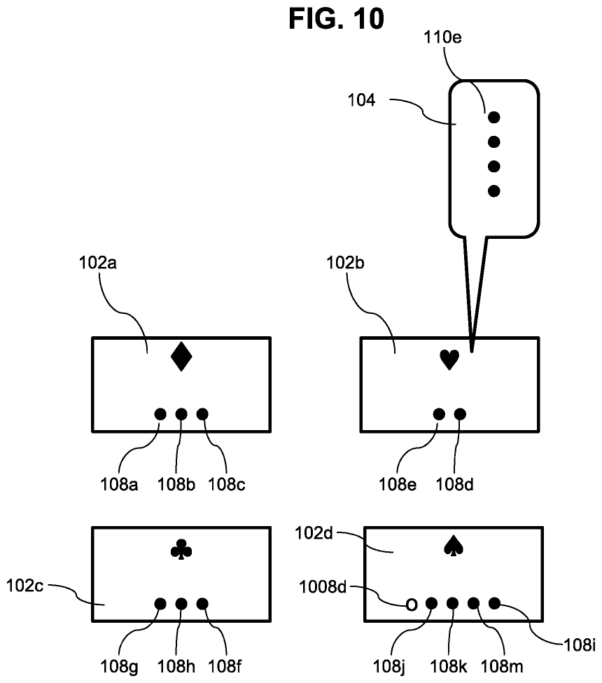

FIG. 10 is a schematic illustration of a game applying conditional probabilities in accordance with an embodiment of the present invention. In some embodiments, a bettor may place a complex bet. For example, a bettor may make a compound bet. For example, FIG. 10 illustrates that bettor 108d bet that hearts 102b would be the least chosen and bet 1008d that spades 102d would be the second least chosen. Optionally pay out is only to a winner who predicted entirely correctly. For example, since, in the example of FIG. 10, bettor 108d missed his bet 1008d on the second least chosen he will receive no payment (even though he correctly predicted the least chosen choice, hearts). If both bets were correct he may receive a larger payout, for example, n²=16 tokens and/or n(n−1)=12 tokens. Alternatively or additionally, there may be different payment schemes.

It is expected that during the life of a patent maturing from this application many relevant technologies will be developed and the scope of the terms is intended to include all such new technologies a priori.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of playing a game comprising:
suppling a set of payout scheme wherein prior to playing according to an unconditional probability of outcomes the payout scheme does not appear to favor a house managing the game;
accepting bets on said outcomes by said house via touching on at least one members of a finite set of potential outcomes;
changing said unconditioned probability of said outcomes to a conditional probability as a result of said accepting said bets;
paying off said bets by said house according to said payout scheme which according to said conditional probability favors the house.

2. The method of claim 1, wherein a bettor places a bet on an outcome decreases a chance of a chosen outcome winning.

3. The method of claim 2, wherein said outcomes include what will be a least bet upon outcome.

4. The method of claim 1, further including:
publicizing rules of the game and the unconditioned probability of the outcomes.

5. A method of playing a game comprising:
suppling a payout scheme wherein prior to playing according to an unconditional probability of outcomes the payout scheme does not appear to favor a house managing the game but which according to a conditional probability after the game will favor the house;
arranging payment to the house organizing said game using a networked device including a touch screen;
sending a finite set of potential outcomes over a network to said networked device;
displaying a set of choices from said set of potential outcomes on said touch screen;
collecting a bet from a bettor, each bet on a respective choice of said set of choices, said collecting resulting from said bettor touching said respective choice on said touch screen;
determining a winning choice of said choices according to a rule dependent on said collecting of said bet and a plurality of other bets;
changing said unconditioned probability of said outcomes to a conditional probability as a result of said collecting said bet and said plurality of other bets in accordance with said rule; and
paying off said bets by said house according to said payout scheme according said conditional probability.

6. The method of claim 5, wherein there are n choices and said scheme is payout of n times an amount bet as a result of selecting a winning choice.

7. (canceled)

8. The method of claim 5, further including:
transmitting said bet by said bettor to said house using the networked device over the network.

9. The method of claim 5, wherein said displaying includes displaying a set of images to the bettor and to a plurality of other bettors and wherein said touching includes touching one image of said set of images.

10. The method of claim 5, further including:
displaying interim results to said bettor and
collecting further bets after displaying said interim results.

11. The method of claim 10, wherein said interim results include an interim winning choice wherein said paying is based on a final winning choice after said further bets.

12. (canceled)

13. The method of claim 5, further including displaying said winning choice.

14. The method of claim 13, wherein said displaying is configured to hide a conditional statistical distribution of said payout scheme.

15. The method of claim 13, wherein said displaying is limited to said bettor and a plurality of bettors who actually bet.

16. The method of claim 5, wherein there are n choices and said payout is greater than n times an amount bet but small enough that a house always wins.

17. The method of claim 5, wherein there are n choices and said payout is greater than n times an amount bet but small enough that a house never loses.

18. The method of claim 5, further including inhibiting communication among a plurality of other bettors during the game.

19. (canceled)

20. (canceled)

21. The method of claim 5, wherein said determining includes designating a least chosen of said choices as the winning choice.

22. The method of claim 9, further comprising said bettor supplying an image of said set of images via said networked device.

23. The method of claim 5, further comprising:
sending information about a population of a plurality of other bettors over said network to said networked device and
displaying said information to said bettor before said collecting.

24. The method of claim 23, wherein each of said plurality of other bettors is associated with a respective networked device, the method further comprising gathering said a portion of said information from each said respective networked device.
